(19) United States
(12) Patent Application Publication
(10) Pub. No.: US 2014/0067782 A1
(43) Pub. Date: Mar. 6, 2014

(54) SOCIAL NETWORK RESPONSES TO QUERIES

(71) Applicants: Roman Waupotitsch, Redmond, WA (US); Michael Ducker, San Francisco, CA (US)

(72) Inventors: Roman Waupotitsch, Redmond, WA (US); Michael Ducker, San Francisco, CA (US)

(73) Assignee: Microsoft Corporation, Redmond, WA (US)

(21) Appl. No.: 13/602,192

(22) Filed: Sep. 2, 2012

(51) Int. Cl. G06F 17/30

(52) U.S. Cl. 707/706; 707/E17.108

(57) ABSTRACT

The process of posing a query to a search engine and to other people may be combined into a unified user experience. In one example, a user enters a query into a search engine on the user's device. The query is forwarded to the search engine, and the search engine returns results. Additionally, the user may post the same query (or an edited version of the query) on social networks. The search engine may be notified that the user has posted the query (or a version of the query) on social networks and may monitor the social networks for people's responses. When people response to the query, the search engine may cause the user to be notified that new human responses to the query are available.

### BACKGROUND

When people want information, they often request the information from a search engine. Search engines can search documents, such as the set of known web pages. Additionally, some search engines may be able to conduct other types of searches: e.g., product searches from shopping sites, geographic searches from map or local sites, image searches, video searches, or various other types of searches.

While search engines often provide the information a user is looking for, one feature of a search engine is that it identifies existing information that can be found algorithmically. In some cases, however, the information that a person is seeking might not be found through a search of existing information.

### SUMMARY

When a user seeks information, one way to get the information is for a user to ask other people, such as the people in the user's social network(s). A search performed through a search engine may be combined with a question to a user's social network in order to return algorithmic results provided by a search engine, and also human-interactive results provided by people in direct response to a user's query. The algorithmic results and interactive results may be provided in an integrated user experience.

In order to request information, a user may enter a query into a search engine. The search engine may then generate results algorithmically, and may return the results to the user. In addition, the user may choose to send the query out to other people, such as those in his or her social network(s) (e.g., Facebook friends, Twitter followers, etc.). As people start to respond to the user's query, their answers may be collected, and those collected answers and may be provided to a user along with the algorithmic results. Since the interactive results are provided by people, they may take longer to obtain than the algorithmic results. Thus, the interactive results may be added to results page as they come in, or the user may be notified that new results are available for viewing.

In one example, a user enters a query into a search engine. An example of such a query is “digital cameras.” The search engine may provide algorithmic results to the query, such as web pages about digital photography or retail sites that sell digital cameras. In addition, a user may choose to pose the query to other people. The user interface for the search engine may allow the user to edit the query into a more human-friendly form. (E.g., the query “digital cameras” might be changed to “What is your opinion on digital cameras?”). The query (possibly in its edited form) may then be posted to the user's social network(s) so that it may be viewed and responded to by the user's contacts. People might provide answers such as “Try the Minolta” or “Forget digital, stick with film.” As these results come in, the results may be added to the results page, if the user is still interacting with the search engine. Alternatively, the user might be notified that new results are available (e.g., through the notification system of the user's phone). The user may then be shown the new results that have come in, or may be provided with a link to obtain the results.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example search interface that may be used to obtain information.

FIG. 2 is a block diagram of an example interface in which a user may edit a query and/or post the query on social media.

FIG. 3 is a block diagram of an example interface in which human-interactive results are shown.

FIG. 4 is a block diagram of an example system in which search engine results and interactive results may be provided.

FIG. 5 is a flow diagram of an example process in which a user may obtain algorithm results and interactive results.

FIG. 6 is a block diagram of example components that may be used in connection with implementations of the subject matter described herein.

### DETAILED DESCRIPTION

People often find information by entering a query into a search engine. Search engines are effective at finding existing information in an algorithmic way. A search engine typically maintains an index of the web, or some other corpus of documents, and finds relevant results by comparing the query to an index. Modern search engines can also find information other than existing web pages. For example, a query may appear to be asking for the weather, a map, flight information, the lowest price on a product, etc., and a search engine may have the ability to find this type of information. One thing that these various types of information have in common is that they are existing pieces of information that can be found algorithmically. At the time the user enters the search query, the search engine answers the query by looking for existing pieces of factual information.

In some cases, however, existing factual information may provide an incomplete answer to the users query. There are some questions that the user may want to pose to specific people interactively. For example, if the user enters the query “digital cameras,” he may be interested in the Wikipedia page on digital photography, as well as professional reviews and retail prices of specific camera models—all of which is existing information. However, the user may also be interested in what the user's friends, or members of the user's social network, think. Search engines are effective at finding information that exists, but are not generally used to perform original research in the form of asking questions to people.

The subject matter described herein provides a way to combine search engine results and interactive personal results in a unified user experience. When a user seeks information, the user enters a query into a search engine. The search engine may obtain information (e.g., web pages, retail prices, maps, images, etc.) in response to the query, and may provide the information in the form of a results page. Additionally, the search engine may offer the user the opportunity to pose the query to people, such as members of the user's social network. The search engine may allow the user to edit the query to make it more appropriate as a question to people—e.g., a query for “digital cameras” may be edited by the user so that it becomes “What digital cameras do you like?” The query (in its edited form, if the user has chosen to edit the query) may then be sent to members of the user's social network.

The search engine may then monitor the social networks for responses to the query. When a response is available, the search engine may cause the user to be notified of the availability of a response. For example, the search engine may push a notification to the user's device, which can be processed through the notification engine of the user's device. The notification may contain the actual response, or may contain a link to the response. If the user is currently viewing results of his or her search when a response comes in, the response may be added to the results page. Any appropriate method may be used to provide the user with people's responses to the query.

In general, using a search engine to find information on the one hand, and asking people questions on the other hand, may be viewed as different aspects of the task of “getting information.” The subject matter herein integrates these different ways of getting information into a unified experience.

It is noted that a system that poses a query to a search engine and to a set of social contacts (or a system that poses one query to a search engine and an associated or related query to a set of social contacts) is different from, and not obvious in view of, a system that allows users to collaborate on the formation of queries. Moreover, a system that poses a query to a search engine, and that also poses the same query (or a related or associated query) to a set of social contacts, is different from, and is not obvious in view of, a system that allows users merely to ask questions of one's social contacts. The former type of system unifies the experience of obtaining both existing information from search engines and interactive information from human sources; the latter type of system is merely a mechanism for asking questions to people.

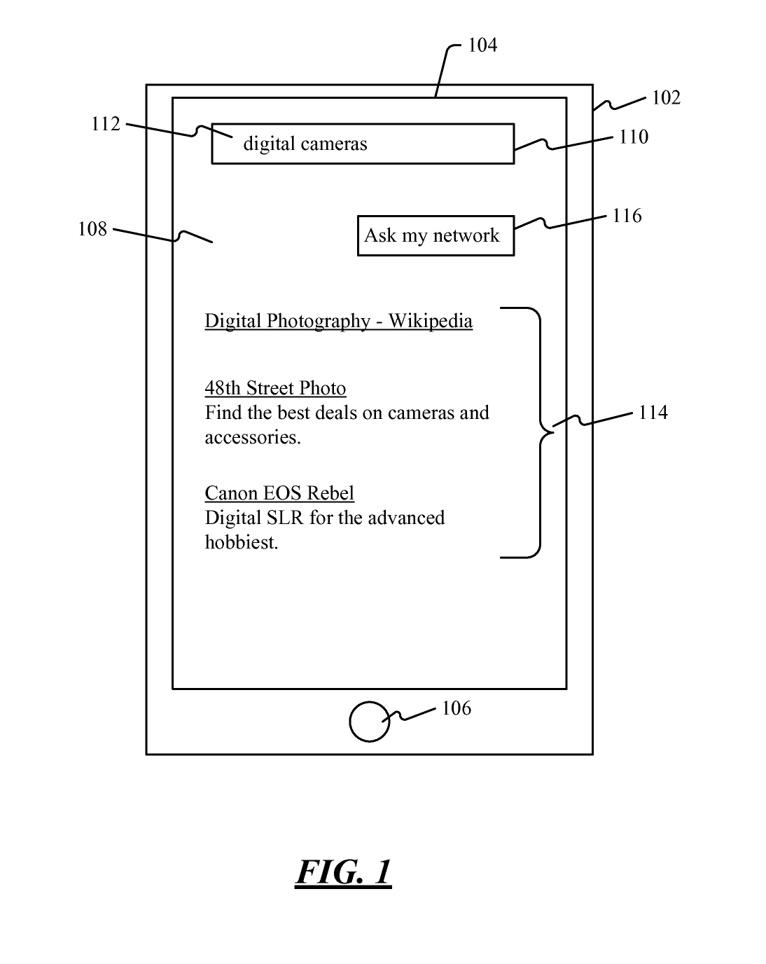

Turning now to the drawings, FIG. 1 shows, on a device, an example search interface that may be used to obtain information. Device 102 may be any type of device that has some computing capabilities, and on which a search may be performed. Device 102 may be a smart phone, tablet computer, personal computer, set top box, or any other appropriate type of device. In FIG. 1, device 102 is depicted as a smart phone, although a smart phone is merely one example of device 102.

Device 102 may have a touch screen 104 that is used both to display information and to receive information. Device 102 may also have an “escape” or “home” button 106. Touch screen 104 and button 106 are merely some examples of input/output hardware that may exist on device 102. In other examples, input/output hardware may include a mechanical keyboard, a standalone monitor, a speaker, a microphone, or various wired or wireless networking technologies (e.g., WiFi, Bluetooth, Ethernet, cellular, etc.).

On the touch screen 104 of device 102, there is shown the interface 108 of a search application. The search application may be a search engine's web site that is visited through a browser, or may be a purpose-built search app that executes on device 102 and accesses a search engine. Interface 108 includes a search box 110. The user of device 102 may enter a query 112 into search box 110. In the example shown, the query is “digital cameras”. There may be a search button that the user clicks to submit the search to the search engine, or the search engine may use incremental search in which search results are returned as the user types.

In response to the query 112, the search engine may provide results 114, which may be displayed on touch screen 104 as part of interface 108. As can be seen, the results that are shows are various web sites: the Wikipedia article on digital photography, the retail site of an electronics retailer named “48^{th} Street Photo”, and the web page for the Canon EOS Rebel, which is a specific model of camera. Results 114 are the type of results that a search engine can find algorithmically: the results include information that the search engine has found from the body of existing information. However, interface 108 also provides the user with the ability to ask people for information about the subject of the query. Thus, interface 108 includes a button 116 (or other activatable element), which allow the user to ask people about the subject of the query. In the example shown, button 116 is labeled “ask my network,” suggesting that the people the user is going to ask are contacts in his social networks (e.g., Facebook friends, Twitter followers, people in the user's e-mail contacts list, etc., or any combination of these types of contacts). However, the user could pose the query to any set of people.

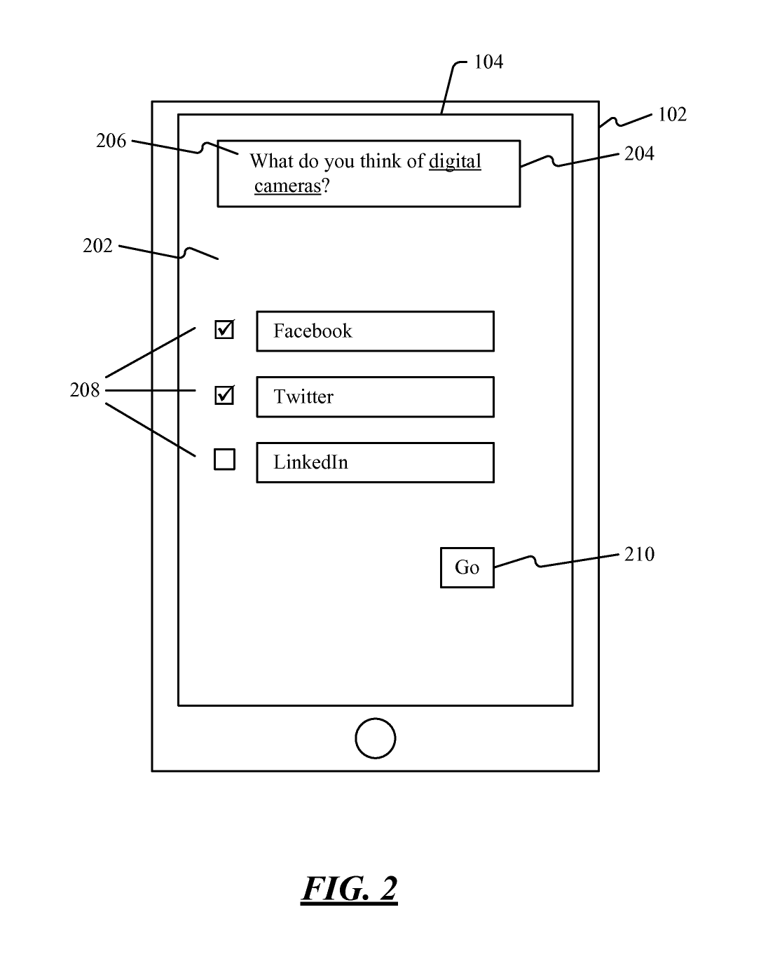

If the user clicks button 116, the user may be presented with an interface that allows the user to edit the query and send the query out to people. An example of such an interface is shown in FIG. 2.

FIG. 2 shows the device 102 that was introduced in FIG. 1. The touch screen 104 of device 102 shows an interface 202, which includes an editing box 204. The user's original query (“digital cameras”) may be automatically filled into the editing box 204. The user may then edit the query to make it more appropriate to present to people as a question. In the example shown, the user has added the words “What do you think of” to the beginning of the original query, and a question mark after the original query, so the whole query 206 reads, “What do you think of digital cameras?” In another example, the system may pre-fill the box with an alternative phrasing of the query, or may suggest more than one alternative phrasings. Editing the query is optional; the user might simply choose to post the original query.

Interface 202 includes elements that allow the user to post query 206. In the example shown, interface 202 includes checkboxes 208 next to the user's various social networks. The user can check, or not check, the boxes depending on the channels through which the user wants to ask his or her question. In the example shown, the user has chosen to post on Facebook and Twitter, but not on Linked-In. Once the user has made his or her selection of social media, the user may click (or otherwise activate) the “go” button 210, which causes the user's question to be posted on the selected social media. For example, if the user has selected Twitter, then query 206 may be tweeted. If the user has selected Facebook, then query 206 may be posted to the user's Facebook wall or timeline as a status update (which may be shown in the Facebook news streams of the user's friends).

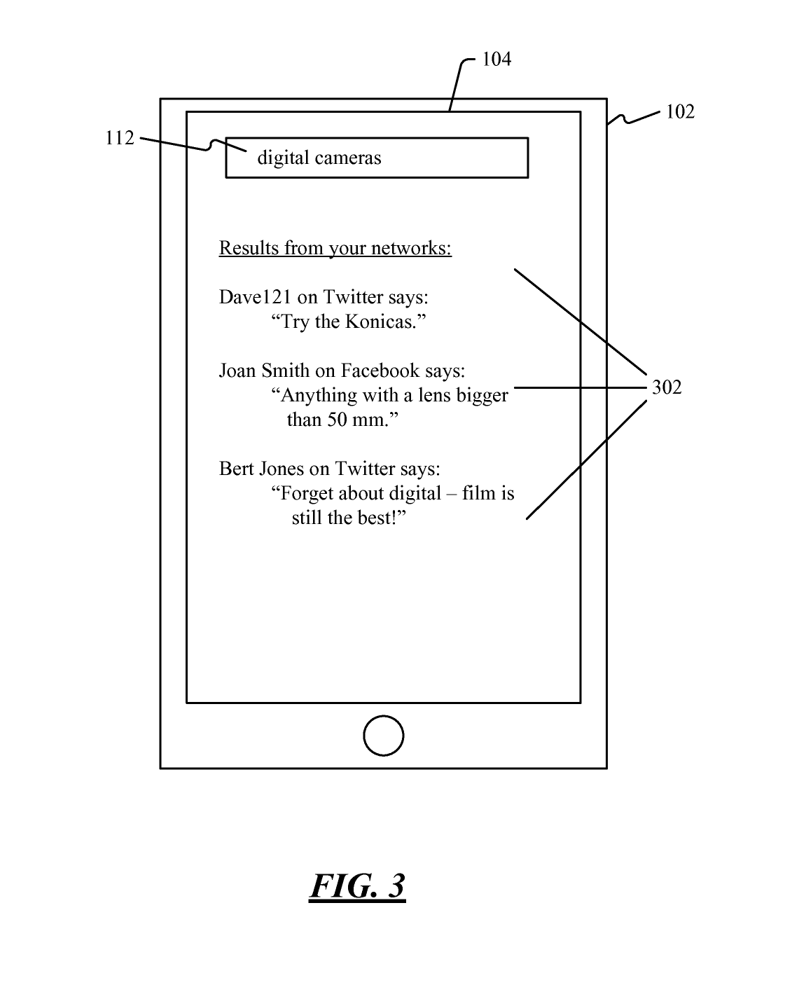

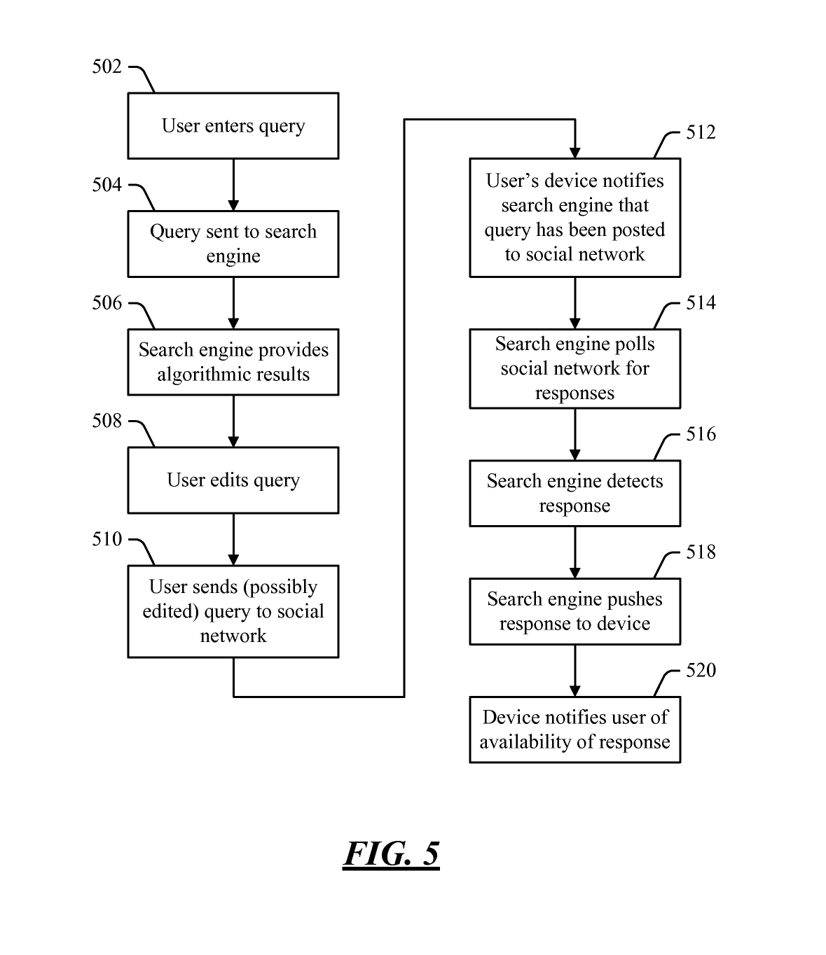

Once the user's query has been posted to social media, the user's social contacts may provide results. FIG. 3 shows some example results from people. (The results shown in FIG. 3 may be referred to as “human-interactive” results, or just “interactive” results, to distinguish these results from the algorithmic results that the search engine provides.) Unlike algorithmic results from a search engine (which can be provided nearly instantaneously), results from people may take some time to come in. The user's social contacts may be offline, or may be responding to other posts. In the discussion associated with FIG. 5 (below), various techniques are described for notifying the user of people's answers to the query. However, FIG. 3 shows a simplified results screen that assumes that several answers have come in.

FIG. 3 shows the device 102 with touch screen 104 that was first shown in FIG. 1. In this example, touch screen 104 shows results 302 from the user's social networks. The interface shown on touch screen 104 may include the original query 112, as a reminder to the user of what question the results are answering.

In the example shown, results 302 include answers from three people. One user—“Dave121” on Twitter—has answered the query with the text “Try the Konica” (where Konica is a brand of camera). Another user from Facebook says “Anything with a lens bigger than 50 mm”. A third user responds with a suggestion to try a film camera. As can be seen, results 302 are not existing information of the type that could be found algorithmically by a search engine. Rather, results 302 are content (text, in this example) that was created and/or curated by human members of a user's social networks in response to the user's query.

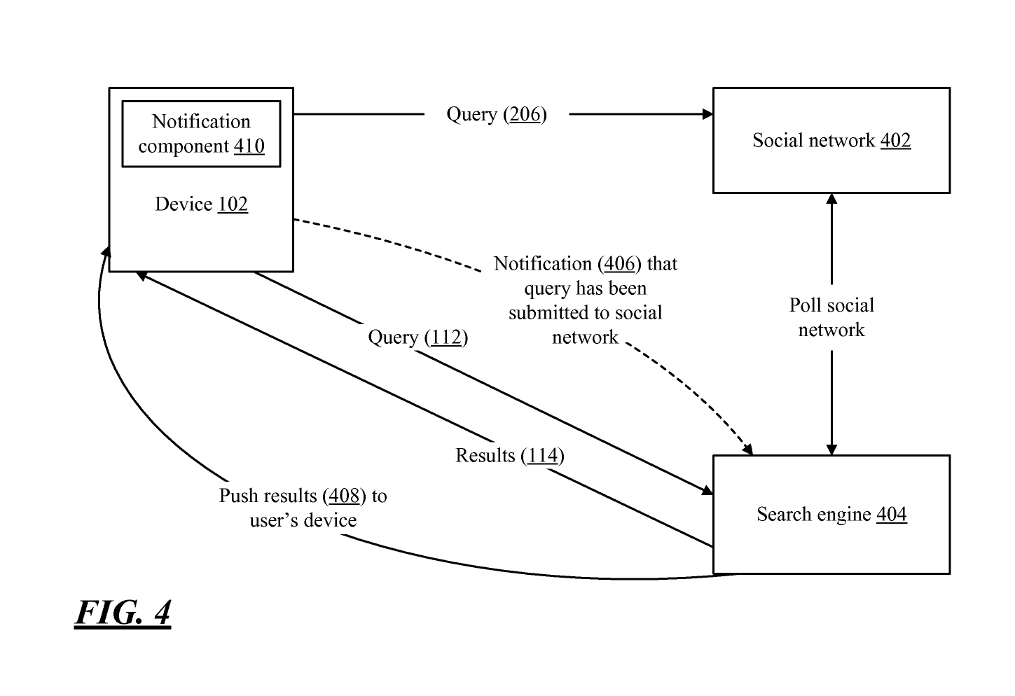

FIG. 4 shows an example system in which search engine results and interactive results may be provided in a unified experience.

Device 102 is communicatively connected to one or more social networks, such as social network 402. Device 102 is also communicatively connected to search engine 404. Examples of social networks are Facebook, Twitter, Linkedln, etc. Examples of search engines are Google, or the BING search engine. Communication between device 102, social network 402, and search engine 404 may be via a computer network such as the Internet, and may involve wired or wireless communications (or some combination of wired and wireless communication).

Query 112 (which may be the query that a user enters on device 102, as shown in FIG. 1) may be sent to search engine 404. In response to query 112, search engine 404 may send results 114 to device 102. Results 114 may be the algorithmic search results the search engine generates. Device 102 may also send query 206 to social network 402. Query 206 may be the same as query 112, or may be a version of query 112 that has been modified to be more appropriate to pose as a question to people. For example, query 112 might be “digital cameras”, and query 206 might be “What do you think of digital cameras?” Social network 402 displays query 206 in whatever form the social network uses to communicate with people. For example, if social network 402 is Twitter, then query 206 may be posted in a user's Twitter feed. If social network 402 is Facebook, then query 206 may be posted on a user's wall or timeline. In addition to sending query 206 to social network 402, device 102 may also send a notification 406 to search engine 404, where notification 406 advises search engine 404 that query 206 has been posted to social network 402. This notification informs search engine 404 to start polling social network 402 for people's answers to query 206. Since the query 206 that is sent to social network 402 may be a different version of the query 112 that was sent to search engine 404, notification 406 may contain information that identifies the two queries as being related to, or associated with, each other. In this way, when search engine 404 finds human-interactive results to query 206, search engine 404 will know that those human-interactive results relate to the same underlying question that search engine 404 answered when it responded to query 112.

As search engine 404 polls information on social network 402, it may learn that a question has been answered. For example, query 206 may be posted on a feed, wall, or timeline, and an answer to query 206 may be posted as a comment or reply to the original post. Or, the original post may be associated with a hashtag, and the reply may use the same hashtag. Any appropriate technique may be used to determine which comments or replies relate to query 206.

When search engine 404 has identified responses to query 206, search engine 404 may push to device 102 the responses. These responses are query results 408. Device 102 may display results 408 in some manner. For example, if the user of device 102 is currently interacting with the search engine (e.g., by being on the search engine's web page, or by using the search engine's app), then results 408 may simply be added to the results page that the user is currently viewing. Moreover, device 102 may have a notification component 410 that delivers, to a user, notifications of events that arise in programs that execute on device 102—e.g., by displaying a pop-up message or dialog box over the user's current screen, by rendering an audio signal, or by any other mechanism. Thus, if the user is not currently interacting with the search engine, then the device 102 may use its notification component 410 to notify the user that a new result is available. The notification to the user may comprise, for example, the result itself, or a link to the result.

FIG. 5 shows an example process in which a user may obtain both algorithmic results from a search engine, and interactive results from people, in a unified experience. Before turning to a description of FIG. 5, it is noted that the flow diagram in FIG. 5 is described, by way of example, with reference to components shown in FIGS. 1-4, although these processes may be carried out in any system and are not limited to the scenarios shown in FIGS. 1-4. Additionally, the flow diagram in FIG. 5 shows an example in which stages of a process are carried out in a particular order, as indicated by the lines connecting the blocks, but the various stages shown in this diagram can be performed in any order, or in any combination or sub-combination.

At 502, the user may enter a query into a search engine—e.g., by visiting the search engine's web page on a browser, or by using the search engine's app. At 504, the query may be sent to the search engine. At 506, the search engine may provide results in response to the query. For example, the search engine may provide the algorithmic results described above.

At 508, the user may edit the query into a form that is appropriate for posting on a social network—e.g., by working the original search terms into the form of a sentence. It is noted that the flow diagram of FIG. 5 shows the algorithmic results being returned before the user edits the query for posting on a social network, although the user could edit the query (and post the query) on the social network prior to obtaining algorithmic results (or even prior to asking the search engine to provide the algorithmic results). Moreover, editing of the query is optional; the user could simply post the original query without any editing.

At 510, the edited or original query may be posted to one or more social networks. At 512, the user's device notifies the search engine that a query has been posted to the social network(s), thereby providing an indication to the search engine that there may be responses to be gleaned from the social network(s). At 514, the search engine polls the social network(s) for responses. As discussed above, the search engine may monitor traffic on the social networks, thereby allowing the search engine to detect when someone has responded to the user's query. (Since the user may impose various privacy controls on his or her social network postings, monitoring of any privacy-controlled information may be performed pursuant to appropriate permission obtained from the user, in order to protect the user's interest in privacy.)

While polling for response, at 516 the search engine may detect that a response to the user's query has been provided by a person—e.g., in the form of a comment on a social network, in the form of a new posting, or in any other appropriate form. At 518, when such a response is detected, the search engine may push the response to the user's device. In one variation, the search engine may send the response to a notification service, which then sends the notification to the device. At 520, the device may notify the user of the response—e.g., by displaying the response to the user, or by displaying an alert that the response is available to be viewed.

There are many variations as to how the above techniques may be carried out. The following is a non-exhaustive description of some variations:

As noted above, the user's original query to a search engine may be edited in order to make it more appropriate for posting on a social network. The original query could be edited without reference to the search engine's algorithmic results. Or, as another alternative, the edited query could incorporate some or all of the algorithmic results. For example, if the query “digital cameras” returns “Canon EOS Rebel”, the system might incorporate both “digital cameras” and “Canon EOS Rebel” into a single editing box. The user could then edit the text to read, “I asked for ‘digital cameras’ and received ‘Canon EOS Rebel’ as a result. What do you think?” The edited query might also contain the name of the service that returned the result (e.g., the BING service).

It is possible that the user may be posing multiple queries concurrently—e.g., one query for “digital cameras”, another for “sushi restaurant”, etc. As responses arrive from the user's social network(s), the user's device may notify the user as to which query the response relates to. For example, the user might receive separate notifications for responses to different queries. The notification itself may contain the query, so the user can see which query the notification relates to. For each query, there may be a separate link pointing only to that query's responses, or the responses to each query may be collected on a separate page or screen for the user to view.

When the user is notified that responses have become available, if the user asks to see the responses (e.g., by following a link, clicking on an icon, etc.), the user might be shown only responses that have come in since the last time the user viewed responses for that query. Alternatively, the user might be shown all responses for a particular query. If the user is shown only responses that have come in since the last time the user viewed responses, there may be a link that the user can follow to view older responses.

In one example, when the user is notified that responses are available, the responses provided to the user's device at the time of notification. In another example, the user is simply notified that responses are available on a social network, and the user is directed to the social network to view the responses.

Since interactive responses from people may come in at varying frequencies, a heuristic may be used to determine how frequently to notify the user that responses are available. For example, there might be a time limit on how often the user is notified of new responses (e.g., no more often than every minute, or every three minutes, etc.). As another example, the user might only be notified every time some number of new responses (e.g., five, ten, etc.) have come in. As another example, there might be a limit based on both quantity and time. E.g., the user could be notified when five new responses have come in, but could be notified at least at three minute intervals if fewer than five responses have come in within the last three minutes. In this way, there would be a time limit on how long a response could be available without the user's having been notified. The limits on time and quantity of notifications may be parameters that the user could adjust.

When the user does receive a response to a query, the user may be able to pose a follow up response. For example, a form may be displayed into which the user could enter a follow-up response, and the user's device may cause the follow-up response to be posted to the user's social network.

In addition to being able to select the social networks to which a response is to be posted (see FIG. 2), the user could limit the audience for a particular query—e.g., by specifying particular people who may view the query, or particular groups of people when definitions of those groups exist (e.g., the user may have defined groups of close friends, business associates, acquaintances, etc., and could pose the query to one or more of those groups).

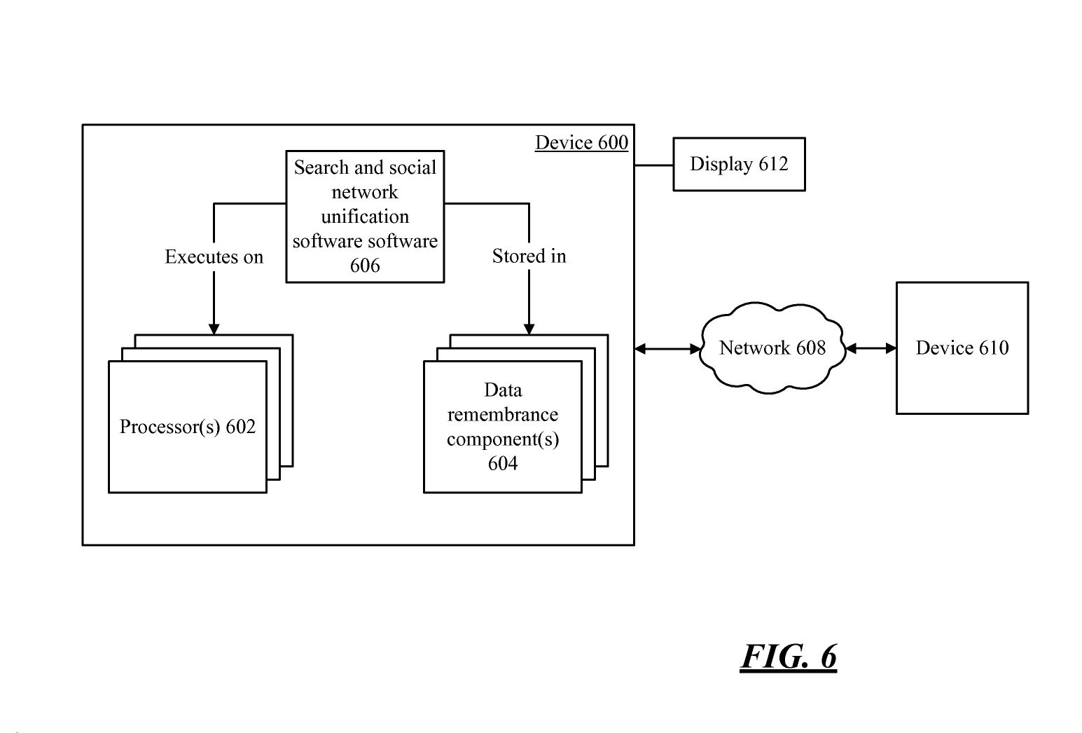

FIG. 6 shows an example environment in which aspects of the subject matter described herein may be deployed.

Device 600 includes one or more processors 602 and one or more data remembrance components 604. Device 600 may be any type of device with some computing power. A smart phone is one example of device 600, although device 600 could be a desktop computer, laptop computer, tablet computer, set top box, or any other appropriate type of device. Processor(s) 602 are typically microprocessors, such as those found in a personal desktop or laptop computer, a server, a handheld computer, or another kind of computing device. Data remembrance component(s) 604 are components that are capable of storing data for either the short or long term. Examples of data remembrance component(s) 604 include hard disks, removable disks (including optical and magnetic disks), volatile and non-volatile random-access memory (RAM), read-only memory (ROM), flash memory, magnetic tape, etc. Data remembrance component(s) are examples of computer-readable (or device-readable) storage media. Device 600 may comprise, or be associated with, display 612, which may be a cathode ray tube (CRT) monitor, a liquid crystal display (LCD) monitor, or any other type of monitor. Display 612 may be an output-only type of display; however, in another non-limiting example, display 612 may be (or comprise) a touch screen that is capable of both displaying and receiving information.

Software may be stored in the data remembrance component(s) 604, and may execute on the one or more processor(s) 602. An example of such software is search and social network unification software 606, which may implement some or all of the functionality described above in connection with FIGS. 1-5, although any type of software could be used. Software 606 may be implemented, for example, through one or more components, which may be components in a distributed system, separate files, separate functions, separate objects, separate lines of code, etc. A device (e.g., smart phone, personal computer, server computer, handheld computer, tablet computer, set top box, etc.) in which a program is stored on hard disk, loaded into RAM, and executed on the device's processor(s) typifies the scenario depicted in FIG. 6, although the subject matter described herein is not limited to this example.

The subject matter described herein can be implemented as software that is stored in one or more of the data remembrance component(s) 604 and that executes on one or more of the processor(s) 602. As another example, the subject matter can be implemented as instructions that are stored on one or more device-readable media. Such instructions, when executed by a phone, computer, or other machine, may cause the phone, computer, or other machine to perform one or more acts of a method. The instructions to perform the acts could be stored on one medium, or could be spread out across plural media, so that the instructions might appear collectively on the one or more computer-readable (or device-readable) media, regardless of whether all of the instructions happen to be on the same medium. The terms “computer-readable media” and “device-readable media” do not include information that exists solely as a propagating signal or solely as a signal per se. Additionally, it is noted that “hardware media” or “tangible media” include devices such as RAMs, ROMs, flash memories, and disks that exist in physical, tangible form; such “hardware media” or “tangible media” are not signals per se. Moreover, “storage media” are media that store information. The term “storage” is used to denote the durable retention of data. For the purpose of the subject matter herein, information that exists only in the form of propagating signals is not considered to be “durably” retained. Therefore, “storage media” include disks, RAMs, ROMs, etc., but does not include information that exists only in the form of a propagating signal because such information is not “stored.”

Additionally, any acts described herein (whether or not shown in a diagram) may be performed by a processor (e.g., one or more of processors 602) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, device 600 may be communicatively connected to one or more other devices through network 608. Device 610, which may be similar in structure to any of the examples of device 600, is a kind of device that can be connected to device 600, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method of providing responses to a first query, the method comprising:
using a processor to perform acts comprising:
receiving said first query from a user;
sending said first query to a search engine;
receiving, from said user, an instruction to post, on a social network, a second query that either is said first query or comprises said first query;
posting said second query on said social network;
receiving, from said search engine, an indication that a person on said social network has provided an answer to said second query; and
notifying said user of availability of human-interactive results to said second query, said human-interactive results comprising said answer.

2. The method of claim 1, said acts further comprising:
after said sending of said first query to said search engine, providing said first query, or an alternative phrasing of said first query, to said user as text in an editing box, said second query being text that is in said editing box after said user edits said first query.

3. The method of claim 1, said acts further comprising:
notifying said search engine that said user has sent said second query to said social network.

4. The method of claim 1, said notifying comprising:
determining that a first number of new human-interactive results have been provided by people since a last time that said user viewed human-interactive results to said second query; and
as a result of said determining, displaying said new human-interactive results to said second query.

5. The method of claim 1, the method being performed on a device that comprises said processor, said device also comprising a notification component that notifies users of events that arises in programs that execute on said device, said notifying comprising:
using said notification component to display a pop-up message or dialog box that contains said human-interactive results.

6. The method of claim 1, said notifying comprising:
providing, to said user, an activatable link to view said results.

7. The method of claim 1, said notifying comprising:
displaying, to said user, page that combines algorithmic results generated by said search engine in response to said first query with said human-interactive results.

8. The method of claim 1, said acts further comprising:
receiving, from said user, a selection of a person, or a group of people, on said social network who are to see said second query.

9. The method of claim 1, said acts further comprising:
prior to said posting, receiving, from said search engine, an algorithmic result; and
displaying, to said user, an editing box that contains said first query and said algorithmic result, said second query being text that is in said editing box after said user edits said first query.

10. A computer-readable medium that stores executable instructions to provide responses to queries, the executable instructions, when executed by a computer, causing the computer to perform acts comprising:
receiving, from a device, a first query entered by a user of said device;
generating first results in response to said first query;
providing said first results to said device;
receiving, from said device, a first notification that said user has posted a second query on a social network, said second query either being or comprising said first query;
polling said social network for responses to said second query;
detecting that a second result has been provided by a person on said social network in response to said second query; and
sending, to said device, a second notification that said second result is available to be viewed by said user.

11. The computer-readable medium of claim 10, said first notification comprising an indication that said second query is associated with said first query.

12. A device comprising:
a memory;
a processor; and
a search component that is stored in said memory, that executes on said processor, that receives from a user of said device a first query, that sends said first query to a search engine, that receives a first result from said search engine, that receives from said user an instruction to post on a social network a second query that is or comprises said first query, that sends said second query to said social network, that receives from said search engine an indication that a person on said social network has provided a response to said second query, and that notifies said user that a second result responsive to said second query is available to be viewed, said second result comprising said response.

13. The device of claim 12, said search component displaying, to said user, an editing box that is filled with said first query, said second query comprising text that is in said editing box after said user has edited said first query.

14. The device of claim 12, said search component determining that said user has not been notified of results provided by people for a number of minutes, said search component notifying said user, as a result of said determining, that new results provided by people on said social network are available.

15. The device of claim 12, said device comprising a notification component that notifies users of events that arise in programs that execute on said device, said search component using said notification component to display a pop-up message or dialog box that contains said second result.

16. The device of claim 12, said device notifying said user that said second result is available by providing a link to said social network at which said second result can be viewed.

17. The device of claim 12, said device notifying said user that said second result is available by displaying all response to said second query that have been received by people on said social network since a last time that said user viewed results from said social network.

18. The device of claim 12, said search component notifying said search engine that said user has posted said second query on said social network and that said second query is associated with said first query.

19. The device of claim 12, said search component receiving, from said user, a selection of a person, or a group of people, on said social network who are to see said second query.

20. The device of claim 12, said search component receiving said first result from said search engine prior to posting of said second query on said social network, said search component displaying, to said user, an editing box that contains said first query and said first result, said second query being text that is in said editing box after said user edits said first query.
